(19) United States
(12) Patent Application Publication
(10) Pub. No.: US 2025/0323539 A1
(43) Pub. Date: Oct. 16, 2025

(54) MOTOR MECHANISM

(71) Applicant: Delta Electronics, Inc., Taoyuan City (TW)

(72) Inventors: Hung-Chi CHEN, Taoyuan City (TW); Han-En CHIEN, Taoyuan City (TW); Chen-Hsing WENG, Taoyuan City (TW)

(21) Appl. No.: 18/908,002

(22) Filed: Oct. 7, 2024

(30) Foreign Application Priority Data
Apr. 15, 2024 (CN) 202420776834.0

(51) Int. Cl. H02K 1/14; H02K 1/18; H02K 5/22; H02K 5/24

(52) U.S. Cl. CPC H02K 1/145; H02K 1/18; H02K 5/225; H02K 5/24

(57) ABSTRACT

A motor mechanism is provided. The motor mechanism includes a metal base, a clip member, a first silicon steel sheet, a second silicon steel sheet, and an insulation member. The metal base includes a protruding portion. The clip member is connected to the metal base. The first silicon steel sheet includes a first central hole and a plurality of first pole teeth. A positioning protrusion is formed on the inner surface of the first central hole and has a positioning hole. The protruding portion passes through the positioning hole. The second silicon steel sheet is stacked on the first silicon steel sheet, and includes a plurality of second pole teeth. The appearances of the first silicon steel sheet and the second silicon steel sheet are different. The insulation member is connected to the first and the second silicon steel sheets. The clip member clips on the insulation member.

### CROSS REFERENCE TO RELATED APPLICATIONS

The present application claims priority of China Utility Model Application No. 202420776834.0, filed Apr. 15, 2024, which is incorporated by reference herein in its entirety.

### BACKGROUND OF THE INVENTION

### Field of the Invention

The application relates in general to a motor mechanism, and in particular, to a motor mechanism having a plurality of silicon steel sheets.

### Description of the Related Art

An electric motor is a machine that converts electrical energy into mechanical energy. Most electric motors operate through the interaction between the current and the magnetic field. With the development of technology, a lot of apparatuses need a motor to provide a driving force.

### BRIEF SUMMARY OF INVENTION

An embodiment of the invention provides a motor mechanism, including a metal base, a clip member, a first silicon steel sheet, a second silicon steel sheet, an insulation member, and a coil. The metal base includes a base portion and a protruding portion connected the base portion. The clip member is connected to the metal base and adjacent to the protruding portion. The first silicon steel sheet includes a first central hole and a plurality of first pole teeth that are extended outwardly. A positioning protrusion is formed on the inner surface of the first central hole. The positioning protrusion protrudes inwardly and has a positioning hole. The protruding portion passes through the positioning hole. The second silicon steel sheet is stacked on the first silicon steel sheet, and includes a second central hole and a plurality of second pole teeth that are extended outwardly. The appearances of the first silicon steel sheet and the second silicon steel sheet are different. The insulation member is connected to the first silicon steel sheet and the second silicon steel sheet, and includes a third central hole. The minimum dimensions of the third central hole are less than or equal to the maximum dimensions of the first central hole and the maximum dimensions of the second central hole. The clip member clips on the insulation member, and the coil winds around the first or second pole teeth.

An embodiment of the invention also provides a motor mechanism, including a motor mechanism, including a metal base, a clip member, a first silicon steel sheet, a second silicon steel sheet, an insulation member, and a coil. The metal base includes a base portion and a protruding portion connected the base portion. The clip member is connected to the metal base and adjacent to the protruding portion. The first silicon steel sheet includes a first central hole and a plurality of first pole teeth that are extended outwardly. A positioning protrusion is formed on the inner surface of the first central hole. The positioning protrusion protrudes inwardly and has a positioning hole. The protruding portion passes through the positioning hole. The second silicon steel sheet is stacked on the first silicon steel sheet, and includes a second central hole and a plurality of second pole teeth that are extended outwardly. The positioning protrusion is exposed from the second central hole in an axial direction. The insulation member is connected to the first silicon steel sheet and the second silicon steel sheet, and includes a third central hole. The minimum dimensions of the third central hole are less than or equal to the maximum dimensions of the first central hole and the maximum dimensions of the second central hole. The clip member clips on the insulation member, and the coil winds around the first or second pole teeth.

In some embodiments, the protruding portion has a plurality of block structures accommodated in the second central hole, and the block structures are extended away from the positioning hole.

In some embodiments, the clip member encloses at least a portion of the protruding portion.

In some embodiments, the clip member comprises an annular portion enclosing a periphery of the metal base.

In some embodiments, the motor mechanism further comprises a shock absorbing member connected to the annular portion.

In some embodiments, the motor mechanism further comprises a hollow frame and a shock absorbing member, the hollow frame surrounds the metal base, and the shock absorbing member is disposed between the hollow frame and the metal base and in contact with the hollow frame.

In some embodiments, the motor mechanism further comprises a case detachably connected to the hollow frame, the case comprises a positioning protruding portion, and the shock absorbing member comprises a positioning slot. When the case is connected to the hollow frame, the positioning protruding portion enters the positioning slot.

In some embodiments, the motor mechanism further comprises a hollow frame, a case, and a connecting terminal. The hollow frame surrounds the metal base and has a first engaging structure and an additional first engaging structure. The case is detachably connected to the hollow frame and has a second engaging structure. The connecting terminal is disposed on the case. When the second engaging structure is connected to the first engaging structure, an opening in the connecting terminal faces a first direction. When the second engaging structure is connected to the additional first engaging structure, the opening of the connecting terminal faces a second direction, and the first direction is different from the second direction.

In some embodiments, the motor mechanism further comprises a shaft, a case, a cantilever structure, and a sealing member. The shaft is accommodated in the third central hole. The case is disposed on a side of the metal base and has a hole, wherein a position of the hole corresponds to a position of the shaft. The cantilever structure is connected to the case and accommodated in the hole. The sealing member is filled into the hole and in contact with the case and the cantilever structure, wherein the sealing member is flexible.

In some embodiments, when the cantilever structure is in an initial position, the cantilever structure is spaced away from the shaft by a distance.

In some embodiments, the motor mechanism further comprises a shaft and a rotating member, the shaft is accommodated in the third central hole, the rotating member is connected to the shaft, and a first hole and a plurality of second holes are formed on the rotating member. In the radial direction, the distance between the shaft and the first hole is less than the distance between the shaft and the second holes. In the radial direction, the first hole is overlapped with at least two second holes.

### BRIEF DESCRIPTION OF DRAWINGS

The invention can be more fully understood by reading the subsequent detailed description and examples with references made to the accompanying drawings, wherein:

FIG. 1 is a schematic diagram of a motor mechanism according to an embodiment of the invention;

FIG. 2 is a schematic diagram of the motor mechanism in another view according to an embodiment of the invention;

FIG. 3 is a cross-sectional view along line A-A in FIG. 1;

FIG. 4 is a schematic diagram of a metal base according to an embodiment of the invention;

FIG. 5 is a schematic diagram of the metal base and a clip member according to an embodiment of the invention;

FIG. 6A is a schematic diagram of a silicon steel sheet assembly according to an embodiment of the invention;

FIG. 6B is a schematic diagram of a first silicon steel sheet according to an embodiment of the invention;

FIG. 6C is a schematic diagram of a second silicon steel sheet according to an embodiment of the invention;

FIG. 7 is a schematic diagram of the silicon steel sheet assembly and an insulation member according to an embodiment of the invention;

FIG. 8 is a cross-sectional view along line B-B in FIG. 1;

FIG. 9 is a schematic diagram of a rotating member according to an embodiment of the invention;

FIG. 10 is a cross-sectional view along line C-C in FIG. 2;

FIG. 11 is a cross-sectional view along line D-D in FIG. 2;

FIG. 12A is a schematic diagram representing that the connecting terminal faces a first direction when a hollow frame and a case are engaged according to an embodiment of the invention;

FIG. 12B is a schematic diagram representing that the connecting terminal faces a second direction when the hollow frame and the case are engaged according to an embodiment of the invention;

FIG. 12C is a schematic diagram representing that the connecting terminal faces another second direction when the hollow frame and the case are engaged according to an embodiment of the invention; and

FIG. 12D is a schematic diagram representing that the connecting terminal faces still another second direction when the hollow frame and the case are engaged according to an embodiment of the invention.

### DETAILED DESCRIPTION OF INVENTION

The making and using of the embodiments of the motor mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

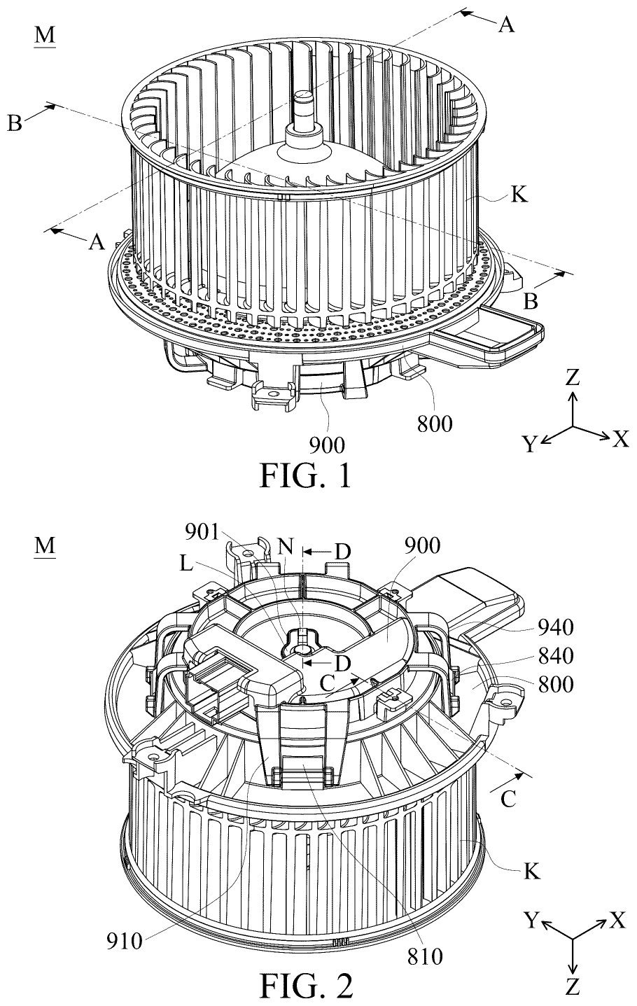

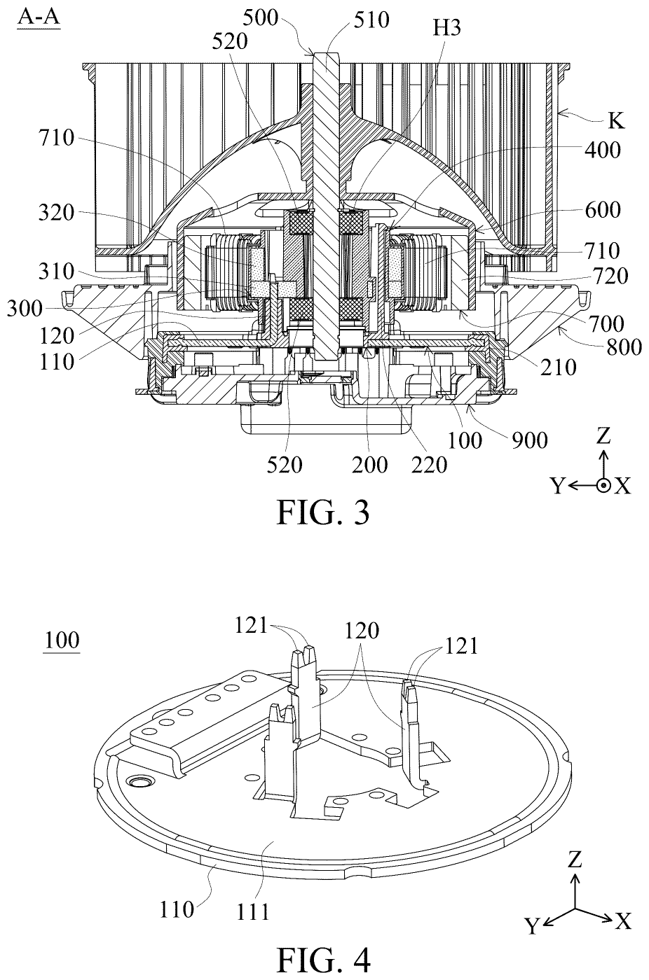

FIG. 1 is a schematic diagram of a motor mechanism M according to an embodiment of the invention, FIG. 2 is a schematic diagram of the motor mechanism M in another view, and FIG. 3 is a cross-sectional view along line A-A in FIG. 1. As shown in FIG. 1 to FIG. 3, in this embodiment, the motor mechanism M primarily includes a metal base 100, a clip member 200, a silicon steel sheet assembly 300, an insulation member 400, a shaft assembly 500, a rotating member 600, a driving assembly 700, a hollow frame 800, a case 900, and a fan blade K. The driving assembly 700 can drive the shaft assembly 500 to rotate relative to the hollow frame 800 and the case 900, and the fan blade K is connected to the shaft assembly 500. Therefore, the fan blade K can also be driven to rotate. In particular, the motor mechanism M can be disposed in the vehicle, the vessel, the aircraft, or other apparatus that requires the fan blade K to rotate, but it is not limited thereto.

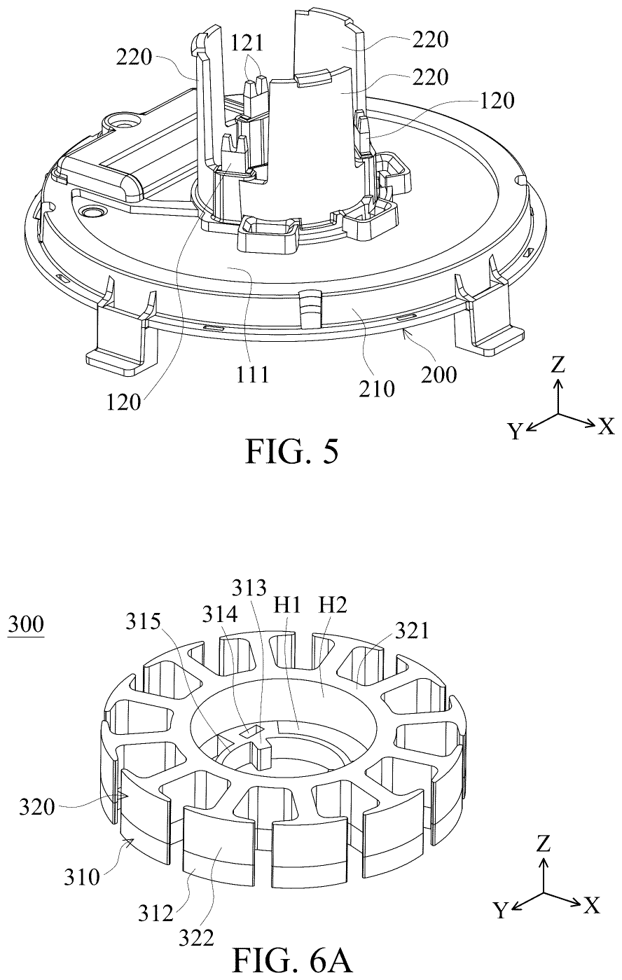

Referring to FIG. 3 to FIG. 5, the metal base 100 includes a base portion 110 and a plurality of protruding portions 120. The base portion 110 substantially includes a disk structure. The protruding portions 120 are connected to the base portion 110 and protrude from the upper surface 111 of the base portion 110. A block structure 121 can be formed on the end of each protruding portion 120 that is not connected to the base portion 110.

The clip member 200 is formed on the metal base 100 by insert molding. In detail, the clip member 200 includes an annular portion 210 and a plurality of clip portions 220. The annular portion 210 encloses the periphery of the base portion 110 of the metal base 100. Each of the clip portions 220 protrudes from the upper surface 111 of the base portion 110 and has a hook structure. In this embodiment, the clip portions 220 can be connected to each other, the protruding portions 120 are adjacent to the clip portions 220, and each protruding portion 120 of the metal base 100 is disposed between two clip portions 220. Therefore, at least a portion of each protruding portion 120 is enclosed by the clip portions 220. For example, the clip member 200 can be made by plastic, but it is not limited thereto.

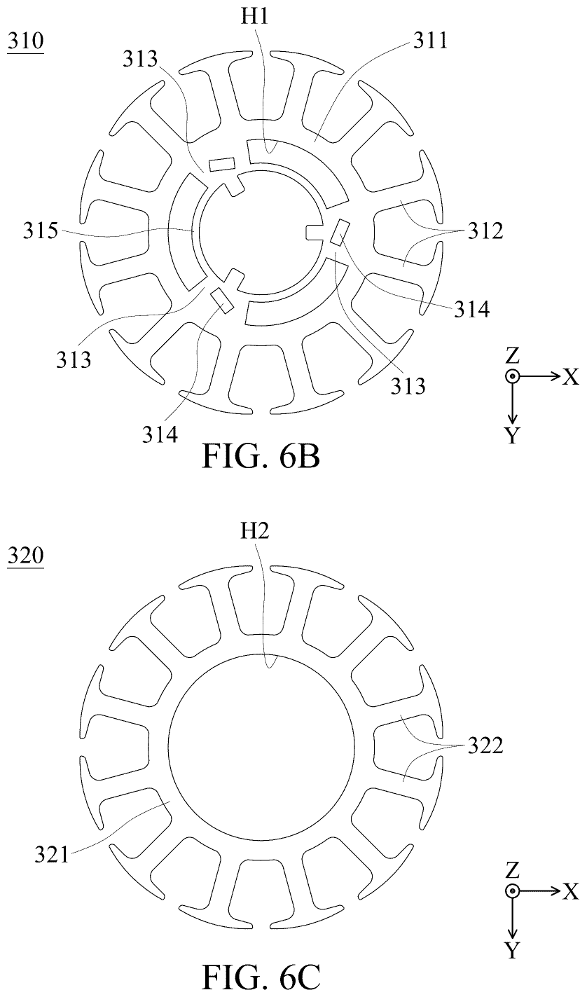

Referring to FIG. 6A to FIG. 6C, the silicon steel sheet assembly 300 includes a first silicon steel sheet 310 and a second silicon steel sheet 320. The first silicon steel sheet 310 includes a first main body 311, a plurality of first pole teeth 312, and a plurality of positioning protrusions 313. The first main body 311 has an annular structure, so that it has a first central hole H1. The first pole teeth 312 are connected to the first main body 311 and extended outwardly from the first main body 311. In this embodiment, each of the first pole teeth 312 has a T-shaped structure, and the gap between the adjacent first pole teeth 312 are the same. The positioning protrusions 313 are formed on the inner surface of the first central hole H1, and each of the positioning protrusions 313 has a positioning hole 314. In this embodiment, the positioning protrusions 313 are connected to each other by a reinforcing ring 315 of the first silicon steel sheet 310 to enhance the structural strength of the first silicon steel sheet 310.

The second silicon steel sheet 320 includes a second main body 321 and a plurality of second pole teeth 322. The second main body 321 has an annular structure, so that it has a second central hole H2. The second pole teeth 322 are connected to the second main body 321 and extended outwardly from the second main body 321. In this embodiment, each of the second pole teeth 322 has a T-shaped structure, and the gap between the adjacent second pole teeth 322 are the same.

As shown in FIG. 6A, when the motor mechanism M is assembled, the second silicon steel sheet 320 can be stacked on the first silicon steel sheet 310 to form the silicon steel sheet assembly 300. Since the shape and the dimensions of the first main body 311 are substantially the same as that of the second main body 321, and the number, the shape and the dimensions of the first pole teeth 312 are substantially the same as that of the second pole teeth 322, when the second steel sheet 320 is stacked on the first silicon steel sheet 310, the first main body 311 and the second main body 321 can be aligned with each other, and the first pole teeth 312 and the second pole teeth 322 can be aligned with each other. Moreover, since there is no protruding portion corresponding to the positioning protrusions 313 disposed inside the second central hole H2 of the second silicon steel sheet 320, the positioning protrusions 313 are exposed from the second central hole H2 of the second silicon steel sheet 320 in the axial direction.

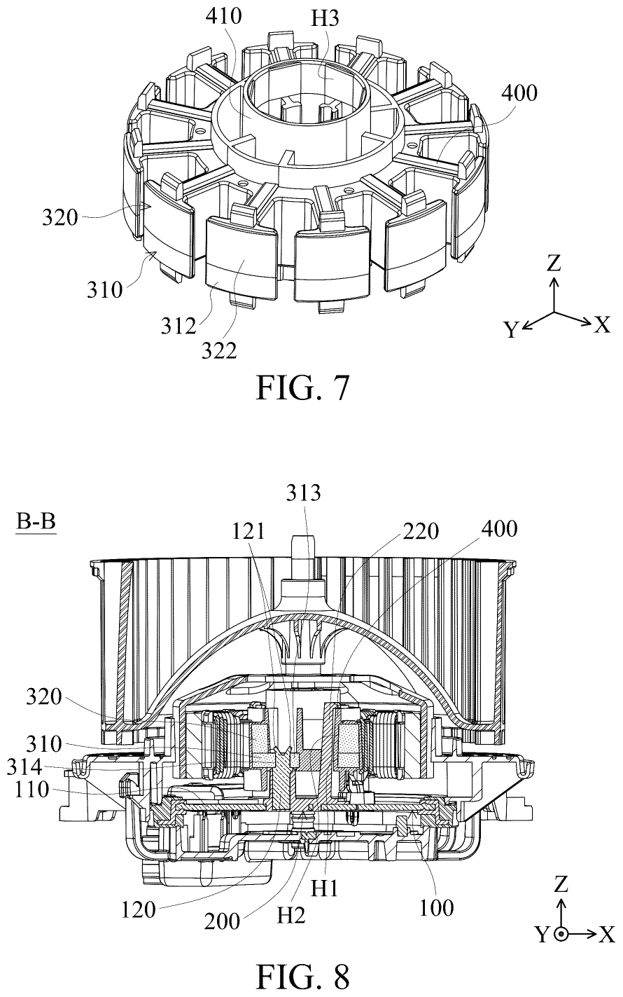

Referring to FIG. 3 and FIG. 7, the insulation member 400 can be connected to or even enclose the first main body 311, the second main body 321, the first pole teeth 312, and the second pole teeth 322 of the silicon steel sheet assembly 300, and can further include a cylindrical portion 410 accommodated in the first central hole H1 and the second central hole H2. The cylindrical portion 410 has a third central hole H3. The minimum dimensions of the third central hole H3 can be less than or equal to the maximum dimensions of the first central hole H1 and the maximum dimensions of the second central hole H2. In this embodiment, the minimum dimensions of the third central hole H3 are less than the maximum dimensions of the first central hole H1 and the maximum dimensions of the second central hole H2, and the protruding portions 120 of the metal base 100 and the clip portions 220 of the clip member 200 is disposed between the third central hole H3 and the first main body 311.

FIG. 8 is a cross-sectional view along line B-B in FIG. 1. As shown in FIG. 3 and FIG. 8, when the motor mechanism M is assembled, the protruding portions 120 can pass the positioning holes 314 of the first silicon steel sheet 310, and the block structures 121 on theirs end can be accommodated in the second central hole H2. It should be noted that, the block structures 121 are extended away from the positioning hole 314. The block structures 121 can be formed by using the special jig to press, and the block structures 121 can be expanded as a Y-shaped structure. Owing to the aforementioned method, the block structures 121 can be overlapped with the positioning protrusions 313 in the Z-axis to affix the silicon steel sheet assembly 300 to the metal base 100. Furthermore, the clip portions 220 of the clip member 200 can also be clipped on the insulation member 400, so as to enhance the fixing effect of the silicon steel sheet assembly 300 and the insulation member 400.

The shaft assembly 500 includes a shaft 510 and a plurality of bearings 520. The shaft 510 and the bearings 520 are disposed in the third central hole H3, and the shaft 510 can be connected to the insulation member 400 via the bearings 520. The rotating member 600 is connected to the shaft 510, and the fan blade K is connected to the shaft 510 too. Therefore, the shaft 510, the rotating member 600, and the fan blade K can be rotated synchronously.

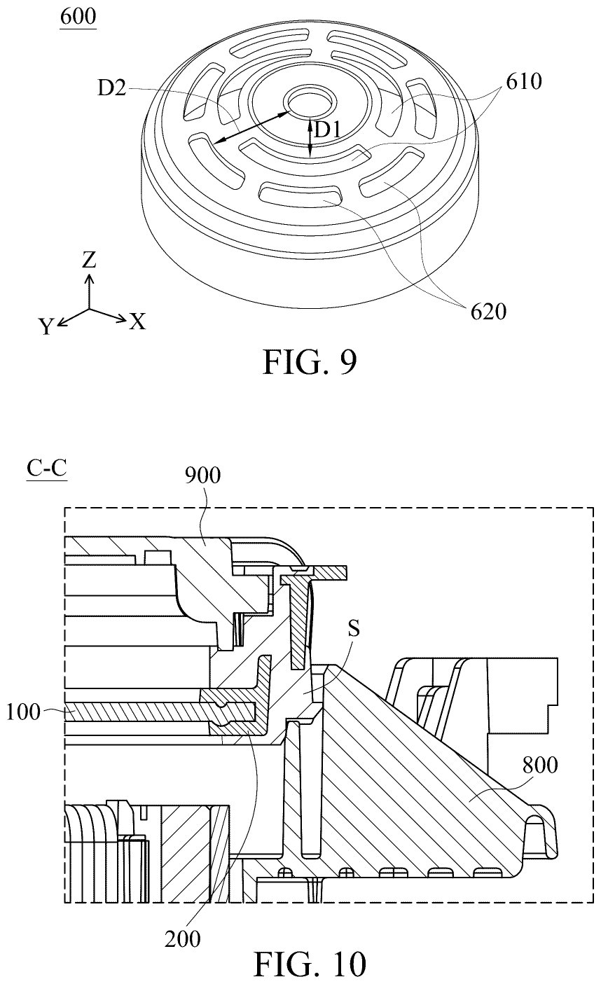

Referring to FIG. 9, in this embodiment, a plurality of first holes 610 and a plurality of second holes 620 are formed on the rotating member 600. In the radial direction, the distance D1 between the first holes 610 and the shaft 510 is less than the distance D2 between the second holes 620 and the shaft 510. Specifically, in the radial direction, each first hole 610 can be overlapped with at least two second holes 620. Thus, the noise of the motor mechanism M when operating can be reduced, and the whole weight of the motor mechanism M can be reduced.

Referring to FIG. 3, the driving assembly 700 includes one or more coils 710 and one or more magnetic members 720. The coil 710 can wind on the first pole teeth 312 and the second pole teeth 322. Since the first pole teeth 312 and the second pole teeth 322 are covered by the insulation member 400, in other words, the coil 710 is not in contact with the first and second pole teeth 312 and 322 directly, the problem of causing the short can be prevented. The magnetic member 720 can be disposed on the rotating member 600, and its position can correspond to the position of the coil 710. In this embodiment, the magnetic member 720 has a ring structure.

When current flow through the coil 710, the electromagnetic effect between the coil 710 and the magnetic member 720 can provide driving force to rotate the rotating member 600, and the shaft 510 and the fan blade K can be driven to rotate synchronously.

The hollow frame 800 can surround the metal base 100 the clip member 200, the silicon steel sheet assembly 300, the insulation member 400, the shaft assembly 500, the rotating member 600, and the driving assembly 700, so as to prevent the aforementioned members from damage due to the collision of the external object. The case 900 can be disposed on a side of the metal base 100 and can be connected to the hollow frame 800 to prevent the electrostatic discharge (ESD) and the electromagnetic interference (EMI). In this embodiment, the hollow frame 800 can further have a locking hole that is configured to connect the external apparatus and/or a cooling channel, but it is not limited thereto.

As shown in FIG. 10, in this embodiment, a shock absorbing member S can be disposed between the hollow frame 800 and the case 900 and can be connected to them. The shock absorbing member S can be formed on the clip member 200 that is on the periphery of the metal base 100 by insert molding. For example, the shock absorbing member S can include rubber. Since the clip member 200 is primarily made by plastic, so that the shock absorbing member S can be tightly attached on the clip member 200. Furthermore, the balance of the motor main body can be achieved by the clip member 200. When the whole motor mechanism M is assembled, it can be engaged with three external balance jigs via the clip member to apply a balance operation.

When the hollow frame 800 and the case 900 are connected, the shock absorbing member S can fill the gap between the hollow frame 800 and the case 900, so that the waterproof function can be achieved. Moreover, since the shock absorbing member S includes the rubber, the shock during the operation of the motor mechanism M can be reduced.

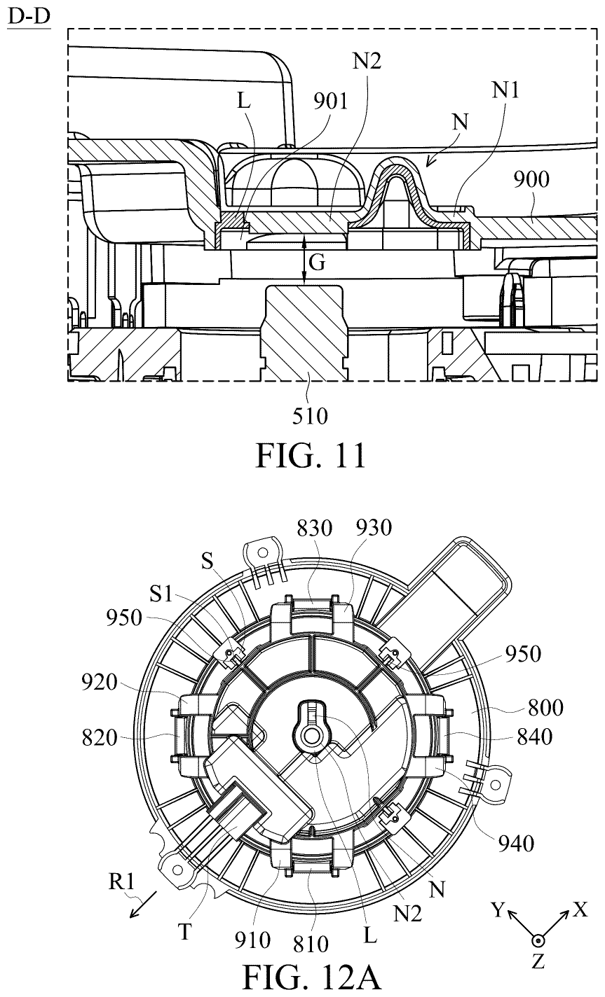

Referring to FIG. 2 and FIG. 11, in this embodiment, the case 900 can include a hole 901, and the position of the hole 901 can correspond to the position of the shaft 510. A cantilever structure N can be connected to the case 900 and accommodated in the hole 901, and a sealing member L can be filled into the hole 901. For example, the cantilever structure N can include metal, so that the arm N1 of the cantilever structure N can be flexible, and the free end N2 of the cantilever structure N can include enough stiffness at the same time. In some embodiments, the cantilever structure N and the case 900 are integrally formed as one piece.

The sealing member L in the hole 901 can be flexible. For example, the sealing member L can include rubber, but it is not limited thereto. The sealing member L can be in contact with the lower surface of the arm N1 of the cantilever structure N. Therefore, the sealing member L can still completely seal the hole 901 even when the arm N1 of the cantilever structure N intensely moves up and down or moves in a large range, and the waterproof function can be achieved.

When the cantilever structure N is in an initial position (a position shown in FIG. 11), the cantilever structure N can be spaced away from shaft 510 by a distance G. For example, the distance G can be ranged from 1 millimeter to 3 millimeters (such as 2 millimeters), but it is not limited thereto. During the assemble of the motor mechanism M, the user can apply the force to the free end N2 of the cantilever structure N, the cantilever structure N can be deformed and move toward the shaft 510, and then the shaft 510 can be pushed and move to a desired position. After that, the user can stop applying the force to the cantilever structure N, and the cantilever structure N can move back to the initial position. Therefore, when the motor mechanism M is operated, the rotation of the shaft 510 is not affected by the cantilever structure N.

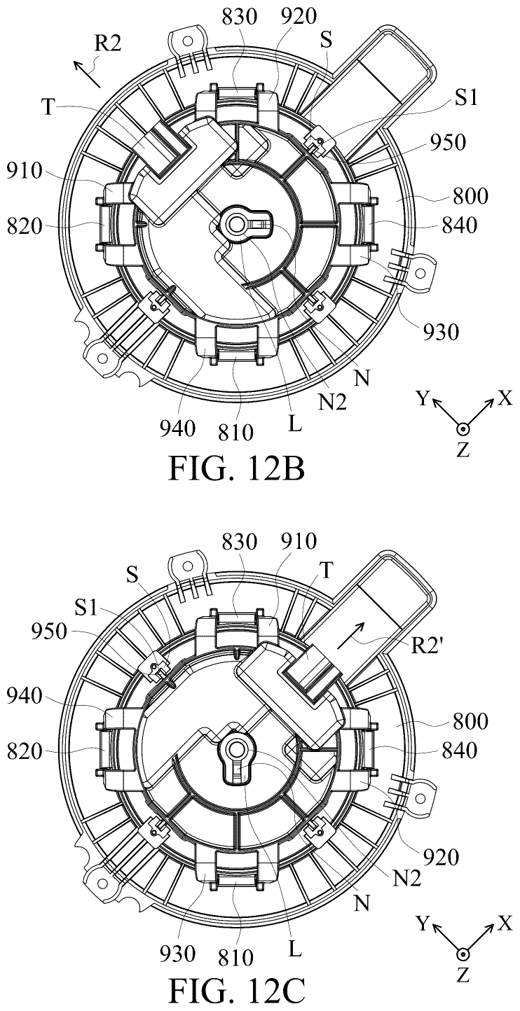

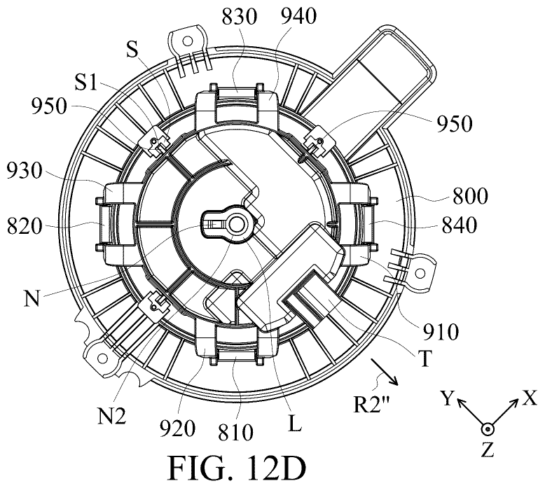

Referring to FIG. 2 and FIG. 12A, in this embodiment, the hollow frame 800 has a plurality of first engaging structures 810, 820, 830, and 840, the case 900 includes a plurality of second engaging structures 910, 920, 930, and 940, and a connecting terminal T is disposed on the case 900. The hollow frame 800 and the case 900 can be detachably connected to each other by the first engaging structures 810, 820, 830, and 840 and the second engaging structures 910, 920, 930, and 940, and the connecting terminal T can face different directions.

For example, in FIG. 12A, the first engaging structure 810 is connected to the second engaging structure 910, the first engaging structure 820 is connected to the second engaging structure 920, the first engaging structure 830 is connected to the second engaging structure 930, and the first engaging structure 840 is connected to the second engaging structure 940. At this time, the connecting terminal T faces a first direction R1.

In FIG. 12B, the first engaging structure 810 is connected to the second engaging structure 940, the first engaging structure 820 is connected to the second engaging structure 910, the first engaging structure 830 is connected to the second engaging structure 920, and the first engaging structure 840 is connected to the second engaging structure 930. At this time, the connecting terminal T faces a second direction R2, and the second direction R2 is different from the first direction R1.

In FIG. 12C, the first engaging structure 810 is connected to the second engaging structure 930, the first engaging structure 820 is connected to the second engaging structure 940, the first engaging structure 830 is connected to the second engaging structure 910, and the first engaging structure 840 is connected to the second engaging structure 920. At this time, the connecting terminal T faces a second direction R2′, and the second direction R2′ is different from the first direction R1.

In FIG. 12D, the first engaging structure 810 is connected to the second engaging structure 920, the first engaging structure 820 is connected to the second engaging structure 930, the first engaging structure 830 is connected to the second engaging structure 940, and the first engaging structure 840 is connected to the second engaging structure 910. At this time, the connecting terminal T faces a second direction R2″, and the second direction R2″ is different from the first direction R1.

Therefore, owing to the aforementioned structures, the user can adjust the direction of the connecting terminal T of the motor mechanism M as required, so that the assemble and the connection of the motor mechanism M can be facilitated.

Moreover, as shown in FIG. 12A to FIG. 12D, in this embodiment, the case 900 includes a plurality of positioning protruding portions 950, and the shock absorbing member S includes a plurality of positioning slots S1. When the hollow frame 800 is connected to the case 900, the positioning protruding portions 950 of the case 900 can enter the positioning slots S1 of the shock absorbing member S to position the case 900.

In summary, an embodiment of the invention provides a motor mechanism, including a metal base, a clip member, a first silicon steel sheet, a second silicon steel sheet, an insulation member, and a coil. The metal base includes a base portion and a protruding portion connected the base portion. The clip member is connected to the metal base and adjacent to the protruding portion. The first silicon steel sheet includes a first central hole and a plurality of first pole teeth that are extended outwardly. A positioning protrusion is formed on the inner surface of the first central hole. The positioning protrusion protrudes inwardly and has a positioning hole. The protruding portion passes through the positioning hole. The second silicon steel sheet is stacked on the first silicon steel sheet, and includes a second central hole and a plurality of second pole teeth that are extended outwardly. The appearances of the first silicon steel sheet and the second silicon steel sheet are different. The insulation member is connected to the first silicon steel sheet and the second silicon steel sheet, and includes a third central hole. The minimum dimensions of the third central hole are less than or equal to the maximum dimensions of the first central hole and the maximum dimensions of the second central hole. The clip member clips on the insulation member, and the coil winds around the first or second pole teeth.

An embodiment of the invention also provides a motor mechanism, including a metal base, a clip member, a first silicon steel sheet, a second silicon steel sheet, an insulation member, and a coil. The metal base includes a base portion and a protruding portion connected the base portion. The clip member is connected to the metal base and adjacent to the protruding portion. The first silicon steel sheet includes a first central hole and a plurality of first pole teeth that are extended outwardly. A positioning protrusion is formed on the inner surface of the first central hole. The positioning protrusion protrudes inwardly and has a positioning hole. The protruding portion passes through the positioning hole. The second silicon steel sheet is stacked on the first silicon steel sheet, and includes a second central hole and a plurality of second pole teeth that are extended outwardly. The positioning protrusion is exposed from the second central hole. The insulation member is connected to the first silicon steel sheet and the second silicon steel sheet, and includes a third central hole. The minimum dimensions of the third central hole are less than or equal to the maximum dimensions of the first central hole and the maximum dimensions of the second central hole. The clip member clips on the insulation member, and the coil winds around the first or second pole teeth.

An embodiment of the invention further provides a motor mechanism, including a shaft assembly, a hollow frame, a case, and a connecting terminal. The hollow frame surrounds the shaft assembly, and has a first engaging structure and an additional first engaging structure. The shaft assembly is enabled to rotate relative to the hollow frame. The case is detachably connected to the hollow frame, and has a second engaging structure. The connecting terminal is disposed on the case. When the second engaging structure is connected to the first engaging structure, an opening of the connecting terminal faces a first direction. When the second engaging structure is connected to the additional first engaging structure, the opening of the connecting terminal faces a second direction, wherein the first direction is different from the second direction.

An embodiment of the invention further provides a motor mechanism, including a shaft assembly, including a shaft assembly, a case, a cantilever structure, and a sealing member. The shaft assembly includes a shaft. The case is disposed on a side of the shaft assembly and has a hole. The position of the hole corresponds to the position of the shaft. The cantilever structure is connected to the case and accommodated in the hole. The sealing member is disposed in the hole.

An embodiment of the invention further provides a motor mechanism, including a shaft assembly, a hollow frame, a case, and a damping member. The hollow frame surrounds the shaft assembly, and the shaft assembly is enabled to rotate relative to the hollow frame. The case is detachably connected to the hollow frame. The damping member is disposed between the hollow frame and the case, and is in contact with the hollow frame and the case.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements. While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A motor mechanism, comprising:
a metal base, comprising a base portion and a protruding portion, wherein the protruding portion is connected to the base portion;
a clip member, connected to the metal base and adjacent to the protruding portion;
a first silicon steel sheet, comprising a first central hole and a plurality of first pole teeth extended outwardly, wherein a positioning protrusion is formed on an inner surface of the first central hole, the positioning protrusion protrudes inwardly and has a positioning hole, and the protruding portion passes through the positioning hole;
a second silicon steel sheet, stacked on the first silicon steel sheet, and comprising a second central hole and a plurality of second pole teeth extended outwardly, wherein the second silicon steel sheet and the first silicon steel sheet have different appearances;
an insulation member, connected to the first pole teeth or the second pole teeth, and comprising a third central hole, wherein minimum dimensions of the third central hole are less than or equal to maximum dimensions of the first central hole and the second central hole, and the clip member clips on the insulation member; and
a coil, winding around the first pole teeth or the second pole teeth.

2. The motor mechanism as claimed in claim 1, wherein the protruding portion has a plurality of block structures accommodated in the second central hole, and the block structures are extended away from the positioning hole.

3. The motor mechanism as claimed in claim 1, wherein the clip member encloses at least a portion of the protruding portion.

4. The motor mechanism as claimed in claim 1, wherein the clip member comprises an annular portion enclosing a periphery of the metal base.

5. The motor mechanism as claimed in claim 4, wherein the motor mechanism further comprises a shock absorbing member connected to the annular portion.

6. The motor mechanism as claimed in claim 1, wherein the motor mechanism further comprises a hollow frame and a shock absorbing member, the hollow frame surrounds the metal base, and the shock absorbing member is disposed between the hollow frame and the metal base and in contact with the hollow frame.

7. The motor mechanism as claimed in claim 6, wherein the motor mechanism further comprises a case detachably connected to the hollow frame, the case comprises a positioning protruding portion, and the shock absorbing member comprises a positioning slot, wherein when the case is connected to the hollow frame, the positioning protruding portion enters the positioning slot.

8. The motor mechanism as claimed in claim 1, wherein the motor mechanism further comprises:
a hollow frame, surrounding the metal base and having a first engaging structure and an additional first engaging structure;
a case, detachably connected to the hollow frame and having a second engaging structure; and
a connecting terminal, disposed on the case, wherein when the second engaging structure is connected to the first engaging structure, an opening of the connecting terminal faces a first direction, wherein when the second engaging structure is connected to the additional first engaging structure, the opening of the connecting terminal faces a second direction, and the first direction is different from the second direction.

9. The motor mechanism as claimed in claim 1, wherein the motor mechanism further comprises:
a shaft, accommodated in the third central hole;
a case, disposed on a side of the metal base and having a hole, wherein a position of the hole corresponds to a position of the shaft;
a cantilever structure, connected to the case and accommodated in the hole; and
a sealing member, filled into the hole and in contact with the case and the cantilever structure, wherein the sealing member is flexible.

10. The motor mechanism as claimed in claim 9, wherein when the cantilever structure is in an initial position, the cantilever structure is spaced away from the shaft by a distance.

11. The motor mechanism as claimed in claim 1, wherein the motor mechanism further comprises a shaft and a rotating member, the shaft is accommodated in the third central hole, the rotating member is connected to the shaft, and a first hole and a plurality of second holes are formed on the rotating member, wherein in a radial direction, a distance between the shaft and the first hole is less than a distance between the shaft and the second holes, wherein in the radial direction, the first hole is overlapped with at least two second holes.

12. A motor mechanism, comprising:
a metal base, comprising a base portion and a protruding portion, wherein the protruding portion is connected to the base portion;
a clip member, connected to the metal base and adjacent to the protruding portion;
a first silicon steel sheet, comprising a first central hole and a plurality of first pole teeth extended outwardly, wherein a positioning protrusion is formed on an inner surface of the first central hole, the positioning protrusion protrudes inwardly and has a positioning hole, and the protruding portion passes through the positioning hole;
a second silicon steel sheet, stacked on the first silicon steel sheet, and comprising a second central hole and a plurality of second pole teeth extended outwardly, wherein the positioning protrusion is exposed from the second central hole in an axial direction;
an insulation member, connected to the first silicon steel sheet and the second silicon steel sheet, and comprising a third central hole, wherein minimum dimensions of the third central hole are less than or equal to maximum dimensions of the first central hole and the second central hole, and the clip member clips on the insulation member; and
a coil, winding around the first pole teeth or the second pole teeth.

13. The motor mechanism as claimed in claim 12, wherein the protruding portion has a plurality of block structures accommodated in the second central hole, and the block structures are extended away from the positioning hole.

14. The motor mechanism as claimed in claim 12, wherein the clip member encloses at least a portion of the protruding portion.

15. The motor mechanism as claimed in claim 12, wherein the clip member comprises an annular portion enclosing a periphery of the metal base.

16. The motor mechanism as claimed in claim 15, wherein the motor mechanism further comprises a shock absorbing member connected to the annular portion.

17. The motor mechanism as claimed in claim 12, wherein the motor mechanism further comprises a hollow frame and a shock absorbing member, the hollow frame surrounds the metal base, and the shock absorbing member is disposed between the hollow frame and the metal base and in contact with the hollow frame.

18. The motor mechanism as claimed in claim 17, wherein the motor mechanism further comprises a case detachably connected to the hollow frame, the case comprises a positioning protruding portion, and the shock absorbing member comprises a positioning slot, wherein when the case is connected to the hollow frame, the positioning protruding portion enters the positioning slot.

19. The motor mechanism as claimed in claim 12, wherein the motor mechanism further comprises:
a hollow frame, surrounding the metal base and having a first engaging structure and an additional first engaging structure;
a case, detachably connected to the hollow frame and having a second engaging structure; and
a connecting terminal, disposed on the case, wherein when the second engaging structure is connected to the first engaging structure, an opening of the connecting terminal faces a first direction, wherein when the second engaging structure is connected to the additional first engaging structure, the opening of the connecting terminal faces a second direction, and the first direction is different from the second direction.

20. The motor mechanism as claimed in claim 12, wherein the motor mechanism further comprises:
a shaft, accommodated in the third central hole;
a case, disposed on a side of the metal base and having a hole, wherein a position of the hole corresponds to a position of the shaft;
a cantilever structure, connected to the case and accommodated in the hole; and
a sealing member, filled into the hole and in contact with the case and the cantilever structure, wherein the sealing member is flexible.

21. The motor mechanism as claimed in claim 20, wherein when the cantilever structure is in an initial position, the cantilever structure is spaced away from the shaft by a distance.

22. The motor mechanism as claimed in claim 12, wherein the motor mechanism further comprises a shaft and a rotating member, the shaft is accommodated in the third central hole, the rotating member is connected to the shaft, and a first hole and a plurality of second holes are formed on the rotating member, wherein in a radial direction, a distance between the shaft and the first hole is less than a distance between the shaft and the second holes, wherein in the radial direction, the first hole is overlapped with at least two second holes.
